(19) United States
(12) Patent Application Publication
(10) Pub. No.: US 2025/0129439 A1
(43) Pub. Date: Apr. 24, 2025

(54) PROCESSES AND SYSTEMS FOR MOLTEN SLAG ENERGY EXTRACTION AND UTILIZATION

(71) Applicant: Senex Technologies LLC, West Seneca, NY (US)

(72) Inventor: Bruce J. Barker, Watertown, NY (US)

(73) Assignee: Senex Technologies LLC, West Seneca, NY (US)

(21) Appl. No.: 18/923,189

(22) Filed: Oct. 22, 2024

Related U.S. Application Data
(60) Provisional application No. 63/592,769, filed on Oct. 24, 2023.

(51) Int. Cl. C21B 3/08; C21B 3/10

(52) U.S. Cl. CPC C21B 3/08; C21B 3/10; C21B 2400/034; C21B 2400/052; C21B 2400/08

(57) ABSTRACT

Methods and systems are provided for extracting and utilizing the energy contained in molten slags generated from metal producing operations. The energy is extracted while the slag is contained within a vessel, such as, a slag pot, after the slag has been discharged from a furnace. The energy is accessed by immersing into the slag a thermally stable treatment vessel, such as, a vessel made of graphite, having an internal cavity. The energy from the slag is transmitted by direct contact of the slag with the surface of the treatment vessel. The treatment vessel and slag may be moved relative to each other to overcome the low thermal conductivity of the slag. Any substance placed within the internal cavity is heated without directly contacting the molten slag. The methods and systems provide for high temperature chemical reactions, energy conversions, or transfer operations within the internal cavity.

### CROSS-REFERENCE TO RELATED APPLICATION

This application claims priority to pending U.S. Provisional Patent Application 63/592,769, filed on Oct. 24, 2023, the disclosure of which is included by reference herein in its entirety.

This application is also related to pending U.S. Non-Provisional Application [File ref.: Barker-002A] filed on the disclosure of which is included by reference herein in its entirety.

### FIELD OF THE INVENTION

The present invention relates to a process for extracting and utilizing the high temperature, high-quality thermal energy released from molten media, such as molten slags and metals, and in particular molten slags generated from high temperature pyrometallurgical processes, as they cool through the various stages of solidification.

### BACKGROUND OF THE INVENTION

The production of molten metal, including steel, is an energy and carbon dioxide [CO₂] intensive process that requires very high temperatures which are often generated at least partially through carbon combustion. The use of carbon in the steelmaking process is estimated to generate one quarter of all the industrial CO₂ produced globally. During metal melting, the molten slag generated contains a significant quantity of energy which is typically not recovered. Decreasing carbon consumption by improving the process efficiency through energy recovery from molten slags will produce significant benefits.

To date, there has been no sustainable, large-scale deployment of any process specific to the recovery and reuse of the high-quality energy contained within molten slag from global steelmaking operations. This is mainly due to the challenging aspects related to molten slag, which include extremely high temperatures, very low thermal conductivity, periodic or discontinuous availability, and increasing degrees of solidification as the molten slag cools below certain temperature thresholds. Each tonne (that is, metric ton) of Basic Oxygen Furnace (BOF) and Electric Arc Furnace (EAF) steel slag that exits the furnace releases around 1.6 GJ of energy as it cools from approximately 1600° C. in the furnace to 20° C. in a typical ambient environment.

Within BOF and EAF steelmaking operations, the molten slag is typically discarded without any recovery and reuse of the energy contained in the molten slag. As the slag quantity generated in these operations is typically 10-15% of the liquid steel weight in the furnace, and since approximately 1,950 million tonnes per year [TPY] of liquid steel is produced globally, the quantity of molten slag generated globally is approximately 195 million tonnes per year. Assuming 1.6 gigajoules per tonne [GJ/T] of energy is contained within the molten slag, 312 million GJ of energy is estimated to be lost annually. This equates to 51 million barrels of oil when using a BOE (Barrel of Oil energy Equivalent) of 6.1 GJ per barrel. Assuming $75/barrel (USD in 2024), this amounts to $3.8 billion per year in energy losses from steelmaking slags. Recovering even 20% of this energy, which is worth over $750 million per year, would generate huge cost, operational, and environmental benefits for the steel industry and global communities.

For these reasons, a process to recover and reuse energy from molten slag has been a goal of researchers and developers for the past four decades, and yet no such process has been commercialized due to the many obstacles that must be overcome. Two main obstacles are the high temperature (˜1,600° C.) and low thermal conductivity (0.1-3 watts per meter degree Kelvin [W/m degree K]) of the slag. The energy contained in the slag is therefore difficult to access and slow to extract.

Another obstacle is that molten slag from BOF and EAF operations is generated intermittently or periodically, as both processes are batch operations. Therefore, the molten slag and metal are generated in batches approximately every 20-90 minutes as a furnace progresses through the different stages of charging, melting and discharging the liquid steel and molten slag before starting the cycle again. Maintaining a stable, continuous, and sustainable energy extraction process is therefore made more difficult by the periodic molten slag supply.

A further obstacle is that the energy recovered must be immediately used, stored, or transported to any final application. In extraction operations that use the energy for steam to electricity generation, the conversion from thermal to electrical energy inherently creates energy losses, as does the transport of the thermal or electrical energy for application elsewhere.

Due to these obstacles, the main energy extraction efforts have been centered around the Blast Furnace (BF) as a relatively constant stream of molten slag is emitted in a semi-continuous or prolonged slag tapping operation. An additional obstacle, however, is that BF slag is typically quickly quenched in water to avoid crystallization during slow solidification. When quickly quenched, BF slag maintains an amorphous glass-like structure with minimal crystallization which enables its use as a cement replacement in building applications. When slow cooled for energy recovery, the crystals that form within BF slag decrease its effectiveness as a cement replacement. As using quick-quenched, amorphous BF slag as a cement replacement is a well-established and valuable application, energy extraction from molten BF slag has not been prioritized.

For all of these reasons, energy recovery from molten iron and steel slags has not been developed and deployed globally on a scale required to capture and utilize the significant energy value contained.

### SUMMARY OF THE INVENTION

Embodiments of the invention in their multiple aspects may be applied to the extraction and utilization of high-quality energy contained in molten slags generated from ferrous and non-ferrous metal producing and refining operations by immersing a treatment vessel containing a material to be thermally treated into the molten slag. The energy may be extracted from the slag while the slag is in a molten (liquid and/or semi-liquid) state and is contained within a containment vessel or slag pot. It is therefore advantageous to access the slag in the slag pot as soon as possible after the slag has been discharged from the furnace. It is also possible to minimize the heat loss from the slag in the slag pot before and during the energy extraction process. Heat loss from the slag may be minimized by insulating the interior surfaces of the slag pot; by providing an insulating barrier, like a refractory-lined lid, over the pot; and/or by making an insulating material addition to the surface of the slag in the pot. For example, a top-insulating barrier may not only minimize radiation losses from the slag surface, but may also prevent a thick plate of solidified slag, or “slag plate,” from forming on the molten slag surface. These and any other methods of minimizing heat loss may facilitate the immersion of the treatment vessel, for example, a graphite treatment vessel, according to aspects of the invention, into the internal volume of the slag in the slag pot.

If a hard slag plate has already formed on the slag surface in the pot, the slag plate can be at least partially removed (for example, “skimmed off”) prior to inserting the graphite treatment vessel into the molten slag volume for the energy extraction process to begin. In another aspect, should a hard slag plate or pieces of slag plate form prior to or during treatment, the slag plate and/or slag plate pieces can be at least partially removed periodically during the process, for example, to facilitate the treatment vessel movement through the slag for the energy extraction process to proceed. In one aspect, should a slag plate form prior to or during treatment, the slag plate may be disrupted and/or re-assimilated into the molten slag by moving the treatment vessel through the slag. For example, in one aspect, any slag plate or slag plate pieces formed on the surface of the molten slag can be contacted or impacted by the treatment vessel to disrupt or “break up” the slag plate or pieces, and preferably, promote re-melting or re-assimilation of the solid slag plate into the molten slag. In one aspect, in addition to disrupting the slag plate, the treatment vessel may be used to agitate the solid slag plate to promote re-melting and re-assimilation of the solid slag plate back into the molten slag, for example, by translating (that is, moving), rotating, and/or reciprocating (for example, up and down) the treatment vessel while the treatment vessel is immersed in the molten slag in the slag pot.

The slag energy may be typically extracted from the slag volume by moving the treatment vessel through the slag pot in a pattern and at a speed which maximizes direct contact and energy flow between the slag volume and the treatment vessel. As the the treatment vessel has been hollowed out from one end, objects or materials placed within the internal space, either before, during or after immersing the treatment vessel into the slag, become exposed to radiant energy at temperatures up to 1600° C.

One embodiment of the invention is a method of treating a substance comprising or including: introducing a substance into an internal cavity of a treatment vessel, for example, a treatment vessel that is capable of maintaining structural functionality in high temperature molten environments (for example, the vessel is “temperature-resistant”); at least partially immersing the temperature-resistant vessel containing the substance into a high-temperature molten medium, for example, molten slag or liquid metal, having a temperature greater than 1,000° C.; allowing the temperature-resistant vessel to be heated by the high temperature molten medium wherein the substance is heated to a treatment temperature; and treating the substance in the internal cavity of the temperature-resistant vessel at the treatment temperature. The substance being heated may comprise one or more of steel making furnace dust, steel mill sludge, steel mill finishing shot blast residue, steel mill scale or other by-product or scrap metals, used steel making refractory-based materials, carbon-containing solids and gases, molten-salt phase-change materials and thermoelectric materials. The high-temperature molten medium may comprise a molten metal slag and/or a liquid metal.

In one aspect, the high-temperature molten medium that receives the temperature-resistant vessel may be positioned in one or more of a furnace, a conduit such as a slag runner or furnace tapping spout, and a molten metal ladle or a slag pot, for example, a slag pot containing a weight of molten slag of between 5 tonnes and 100 tonnes.

In one aspect, the temperature-resistant vessel may comprise a graphite-containing vessel, for example, a substantially solid graphite vessel having an internal cavity.

In one aspect, the practice of at least partially immersing the temperature-resistant vessel may comprise immersing the temperature-resistant vessel into the high-temperature molten medium wherein an upper extremity of the vessel is located above a surface of the high-temperature molten medium. In one aspect, the method may further comprise translating or rotating the at least partially immersed, temperature-resistant vessel within the high-temperature molten medium. For example, in one aspect, the at least partially immersed, temperature-resistant vessel may be moved in a path at a speed to enhance thermal energy transfer from the high-temperature molten medium to the vessel and to the substance contained within the vessel.

In one aspect, the method may further comprise monitoring at least one of a temperature of the substance contained within the vessel, the temperature of the high-temperature molten medium, a viscosity of the high-temperature molten medium, a resistance to movement of the temperature-resistant vessel in the high-temperature molten medium, and a residence time of the temperature-resistant vessel within the high-temperature molten medium, and wherein removing the temperature-resistant vessel from the high-temperature molten medium is practiced when at least one of the temperature of the substance contained within the vessel, the temperature of high-temperature molten medium, the viscosity of the high-temperature molten medium, the resistance to movement of the temperature-resistant vessel in the high-temperature molten medium, and the residence time of the temperature-resistant vessel in the high-temperature molten medium before the viscosity of the high-temperature molten medium reaches a threshold. For example, the threshold temperature within the substance contained within the vessel may be at least 600° C., or at least 800 degrees C., or at least 1000° C.; the threshold viscosity of the molten medium may be at most 25 Pascal-seconds [Pa-s]; and the threshold residence time within the molten medium may be at most 60 minutes.

In one aspect, the high-temperature molten medium temperature is greater than 1,200° C.; or greater than 1,400° C.; or greater than 1,600° C.

In one aspect, the internal cavity of the temperature-resistant vessel may comprise an open internal cavity having an open end, for example, an open end which remains above the surface of the molten medium, wherein the method further comprises, after introducing the substance into the open internal cavity of the temperature-resistant vessel, covering the open end of the cavity with a cover.

In one aspect, the high-temperature molten medium may comprise at least some solidified molten media, and wherein the method further comprises, prior to at least partially immersing the temperature-resistant vessel into the high-temperature molten medium, removing and/or disrupting the at least some solidified media from the high-temperature molten medium.

In one aspect, treating the at least one substance in the internal cavity of the temperature-resistant vessel at the treatment temperature is practiced for at least 5 minutes; or for between 5 minutes and 60 minutes; or for between 7 minutes and 40 minutes; or for between 10 minutes and 30 minutes; or for between 12 minutes and 20 minutes.

In one aspect, treating may comprise chemically reacting, energy converting, energy transferring, for example, gasifying coal or by-product carbon units remaining from the iron and/or steel production process; reforming of hydrocarbons; decomposing of methane to generate carbon monoxide and hydrogen synthesis gas; separating precious metals from waste electronic substrates; transferring energy to molten-salt phase-change materials for storage, transport, and use outside of the reactor; generating steam from a water-containing substance; generating electricity via a thermo-electric effect; calcining at least one of used refractory materials and by-products of treating aluminum salt slag; and/or melting of scrap metal.

In one aspect, the treatment temperature of the substance contained within the vessel may be at least 600° C.; or at least at least 1,000° C.; or at least 1,200° C. or at least 1,400° C.

In one aspect, the high-temperature molten medium is positioned in a slag pot, for example, a slag pot having a weight of molten medium of between 5 tonnes and 100 tonnes.

In one aspect, the one or more internal cavities of the temperature-resistant vessel may have open cavities having an open end, and wherein the system further comprises a cover positioned over the open end of the one or more open cavities.

In one aspect, the high-temperature molten medium of the system comprises a temperature greater than 1,000° C.; or greater than 1,200° C.; or greater than 1,400° C., or greater than 1,600° C.

A further embodiment of the invention is a high-temperature treatment vessel comprising or including: a temperature-resistant cylindrical body having at least one internal cavity adapted to receive a substance for treatment; wherein the cylindrical body is adapted to withstand a temperature of at least 1,000° C. without failure or deformation. In one aspect, the at least one internal cavity comprises one internal cavity. In one aspect, the temperature-resistant cylindrical body comprises at least one of a graphite-containing cylindrical body, a magnesium oxide-containing cylindrical body, a silicon carbide-containing cylindrical body, and a refractory metal-containing cylindrical body. In one aspect, the graphite-containing cylindrical body comprises substantially graphite.

In one aspect, the cylindrical body may comprise a circular cylindric body, a cylindrical body, an elliptical body, or a polygonal body.

In one aspect, the at least one internal cavity of the cylindrical body comprises at least one open internal cavity having an open end, and wherein the cylindrical body further comprises a removable cover adapted to mount to, or be positioned over, the open end.

In one aspect, the internal cavity of the temperature-resistant cylindrical body may comprise surfaces having enhanced thermal emissivity compared to a material of the temperature-resistant cylindrical body. For example, the surfaces having enhanced thermal emissivity may comprise a coating having enhanced thermal emissivity compared to a material of the temperature-resistant cylindrical body.

In one aspect, the cylindrical body is adapted or designed to withstand a temperature of at least 1,200° C. without failure or deformation; or at least 1,400 degrees C. without failure or deformation; or at least 1,600° C. without failure or deformation.

Another embodiment of the invention is a system for treating a substance comprising or including: a temperature-resistant vessel having an internal cavity adapted to receive a substance; a feed system having an outlet positioned to introduce the substance into the internal cavity of the temperature-resistant vessel; and a conveyor system adapted to at least partially immerse the temperature-resistant vessel containing the substance into a high-temperature molten medium, for example, in a slag pot, having a temperature greater than 1000° C. and adapted to remove the temperature-resistant vessel from the high-temperature molten medium; wherein the temperature-resistant vessel is adapted to treat the substance in the internal cavity at a treatment temperature when the temperature-resistant vessel is at least partially immersed into the high-temperature molten medium. In one aspect, the temperature-resistant vessel used in the system may be one of the temperature-resistant vessels disclosed herein.

In one aspect, the feed system of the system may have a feeding conduit, for example, a reciprocating feeding conduit adapted to reciprocate into and out of the one or more cavities of the temperature-resistant vessel.

In one aspect, the system may further include a gas collection system operatively connected to a gas outlet in the cover of the temperature-resistant vessel. The gas collection system may comprise a gaseous metal condenser and/or a filter adapted to separate particulate matter from a gas. The gaseous metal condenser may be a gaseous zinc condenser or a gaseous lead condenser.

Another aspect of the invention is a method of treating steel-making refuse comprising or including: introducing steel making refuse, for example, waste dust from an electric arc furnace (EAF), into an internal cavity of a temperature-resistant vessel; at least partially immersing the temperature-resistant vessel containing the steel making refuse into a high-temperature molten medium having a temperature greater than 1,000 degrees C.; allowing the temperature-resistant vessel to be heated by the high temperature molten medium wherein the steel making refuse is heated to a treatment temperature; and treating the steel making refuse in the internal cavity of the temperature-resistant vessel at the treatment temperature. The steel-making refuse may comprise steel making furnace dust, steel mill sludge, steel mill finishing shot blast residue, steel mill scale or other by-product or scrap metals, and/or used steel making refractory-based materials. The steel-making refuse may be pelletized steel-making refuse and/or agglomerated steel-making refuse.

In one aspect, the steel-making refuse treated may comprises at least some zinc-containing materials, and wherein treating the steel making refuse in the internal cavity of the temperature-resistant vessel at the treatment temperature may comprise generating zinc-containing gases or off-gases, and wherein the method may further comprise capturing at least some of the generated zinc-containing gases or off-gases. In one aspect, capturing at least some of the generated zinc-containing gases or off-gases may comprise oxidizing the generated zinc-containing gases or off-gases to yield at least some zinc oxide (ZnO)-containing particulate and/or condensing the generated zinc-containing gases to yield at least some metallic zinc (Zn).

In one aspect, the steel-making refuse may be a powdered, pelletized, tableted, granulated, briquetted, or extruded steel-making refuse. In one aspect, the method may be practiced on-site at a steel plant.

In one aspect, the temperature of the high-temperature molten medium of the method is greater than 1,200° C.; or greater than 1,400 degrees, or greater than 1,600° C.

In one aspect, the treatment temperature of the substance contained within the vessel of the method may be at least 600° C., or at least 1,000° C., or at least 1,200° C. or at least 1,400° C.

In one aspect of the invention, the slag energy typically can be extracted from the slag volume by moving the vessel, or treatment vessel, through the slag pot in a pattern and at a speed which maximizes direct contact and energy flow between the slag volume and the vessel. In one aspect, the vessel may be hollowed out from one end to create an internal space or cavity, objects or materials may be placed within the hot internal space or cavity (for example, either before, during or after immersing the vessel into the slag), and the objects or materials may be exposed to intense radiant energy, for example, at temperatures up to and exceeding 1600° C.

According to aspects of the invention, the extraction of thermal energy occurs as energy from within the slag is transmitted by direct contact with the surface of the vessel, and then throughout the vessel. Once heated, the internal space or cavity becomes a “heated chamber,” for example, similar to the inside of a tube or box furnace. Anything placed inside the internal “heated chamber” is therefore heated without directly contacting the molten slag and without using any additional source of combustion to generate the high temperatures required to initiate and to sustain the treatment of the material placed inside the internal space or cavity of the vessel.

According to one aspect of the invention, at temperatures above 550° C., much of the energy transfer to the substance being treated is via thermal radiation and is where surfaces begin to glow red. At about 1300° C., materials reach a level of incandescence where they appear to be bright white. At about 1300° C. and above most of the energy transfer to the substance being treated is via thermal radiation where no physical contact is needed between the surfaces surrounding the internal chamber of the vessel and the contents of the chamber. It is believed that conduction and convection provide the balance of the energy transferred to, and within, the contents of the chamber.

The benefits of this indirect method of heating according to aspects of the invention include the ability to control, for example, precisely control, the gas chemistry within the internal chamber of the treatment vessel by, for example, adding very small quantities of oxidizing, reducing, or inert gases into the chamber depending on the process requirements. Since typically no combustion gases are generated in the chamber, the total gas volume exiting the chamber may be minimized, which in turn may minimize the size of the off-gas collection system that may be attached to the top of the treatment vessel. In another aspect, eliminating the need for carbon-combustion may also limit the generation of CO₂ within the system to only reduction reaction-related quantities and not combustion-related quantities. In addition, minimizing the gas volume leaving the process according to aspects of the invention may also reduce energy losses by minimizing the volume of hot off-gases exiting the internal chamber of the treatment vessel.

In one aspect, since the low thermal conductivity of the slag may minimize energy losses through the walls of the slag pot, and since the slag surface can be insulated to minimize radiant heat losses through the top of the pot, the energy may be contained within the pot and thus remains available for extraction and utilization. Therefore, according to an aspect of the invention, a vessel immersed within the slag in the slag pot may be able to effectively extract energy through most of its external surface area with minimal losses. This is in direct contrast to any heat recovery approach that requires the slag to be dumped out of the slag pot in order to increase the slag surface area for energy recovery. Also, as the energy is extracted, for example, slowly extracted by typically moving the treatment vessel and the volume of the slag relative to each other, the slag solidification may occur very slowly and uniformly throughout the entire volume of the slag which may extend the time available to extract and utilize the energy.

In one aspect, as the methods and systems disclosed herein may specifically employ molten slags which are contained within a molten medium containment vessel, such as a slag pot, and may not involve blast furnace slags flowing through a runner, or hot slags that have already been completely solidified, the methods and systems of the invention may not be restricted by the need to have an amorphous slag after solidification. Slow cooling of the slag starting from high temperatures up to 1750 degrees C. may therefore be acceptable which thereby allows for the collection of high-quality energy, while also extending the time period during which the energy extraction can occur. As BOF, EAF, and AOD steel-making slags may be mainly used in aspects of the invention disclosed herein, energy recovery and utilization may be the main objectives of aspects of the invention, unlike BF slag's amorphous quality for use after solidification.

However, as the energy recovery depends on maintaining a low enough viscosity for the energy-absorbing object (like a hollowed-out graphite treatment vessel) to be circulated or rotated within the bulk of the slag while it is contained within the slag pot, there is a limit to the amount of energy than can be extracted from one slag pot before the molten slag viscosity increases to where the treatment vessel must be removed from the pot to prevent it from becoming trapped within the solidifying slag. This then allows the treatment vessel to be reused in subsequent slag pots, which, during typical steelmaking cycles, may be generated every 20-90 minutes. According to one aspect of the invention, the treatment vessel may therefore be ideally immersed into the next, hotter slag pot after the slag pot is delivered from the furnace to continue the energy extraction process disclosed herein. This sequencing of energy extraction from one slag pot to the next allows any process that uses the energy extracted to proceed in a relatively continuous or semi-continuous manner. The sequential and ongoing supply of slag pots with hotter slag thereby creates a substantially continuous supply of energy for use in high temperature processing according to aspects of the invention. For example, if the treatment vessel remains immersed in one slag pot until the next slag pot arrives, then the core temperature of the treatment vessel may only drop marginally while the treatment vessel is being transferred from one slag pot to the next. A relatively high temperature may thereby be maintained within the internal chamber of the treatment vessel to allow high temperature processing to proceed in a substantially continuous manner even while switching from one slag pot to the next slag pot. In one aspect, for example, to minimize heat loss, a hot treatment vessel can also be placed within a heated or thermally-insulated, and reducing or inert gas-controlled enclosure to maintain a high temperature of the hot treatment vessel and minimize oxidation of the graphite, for example, in the period between being immersed in one slag pot and then in the next slag pot.

In one aspect, maximizing the use of each graphite treatment vessel helps minimize the costs of the substantially continuous process. Although graphite is not the only choice for conducting the energy extraction, it is a primary choice due to its high thermal shock resistance, high thermal conductivity, high temperature dimensional stability, high emissivity, low coefficient of thermal expansion, high melting point, easy machinability and increasing compressive and flexural strength at increasing temperatures. Graphite is also not wetted by molten slags, thereby preventing a large buildup up solidified slag on the surface of the treatment vessel which may otherwise decrease the thermal conductivity as well as causing other operational difficulties. Large graphite electrodes, slabs, and blocks are also readily available that can be easily machined to create the required chamber within the treatment vessel. Optionally, thin refractory or ceramic coatings can be applied to the treatment vessel surface to minimize oxidation rates once the treatment vessel, which may have a temperature of greater than 1000° C., is lifted out of the molten slag. In one aspect, a specialty coating may be applied to the inside surface walls of the internal chamber of the treatment vessel to maximize the emissivity of these surfaces and maximize the amount and rate of radiant energy emitted and utilized.

According to one aspect, the slag temperature and viscosity at which the treatment vessel is removed from the slag may depend upon the slag chemistry. For example, the slag chemistry may dictate which chemical compounds in the molten slag are the first to solidify within the molten slag, and the amount of each chemical compound which is present at any given temperature. The type and amount of each compound forming through solidification of different slag chemistries can be predicted by using FactStage, an integrated database computing system in chemical thermodynamics. For example, in one aspect, once the slag temperature drops to a point where the volume fraction of solid particles within the molten slag reaches a critical maximum, the viscosity of the molten slag becomes too high for the process to continue in that slag pot.

In another aspect of the invention, a plurality of slag pots containing molten media may be used to extract energy as disclosed herein. For example, after immersion of a treatment vessel and treatment of the substance in the treatment vessel in a first slag pot, the process/reaction can continue where the treatment vessel is immersed into a new or second slag pot, different from a first slag pot, which contains slag that is again, for example, in the 1,500° C. to 1,750° C. temperature range. The energy extraction process may only be possible when accessing slags with viscosities below a certain maximum threshold. These are slags in the higher temperature ranges which contain a minor volume fraction of solid phases such that movement of the treatment vessel within the volume of the slag, or circulation of the slag around the treatment vessel, is possible for rapid and continuing energy extraction to occur. Of the three ranges that have been described for potential energy recovery from hot slags, this range is within stage one (the liquid region), and into stage two where a mix of liquid and solid phases coexist within the molten slag. As the energy-extracting treatment vessel must be removed before the crystal solids fraction reaches a threshold amount, also known as the “critical volume fraction of solids,” no energy extraction may be possible from that slag pot after this threshold viscosity is reached. The threshold volume of solids is estimated to be between 30% and 50% for BOF slags, as this is when the slag viscosity starts to rapidly increase. In this lower temperature range, estimated to be between 1,250° C. and 1,350° C. depending on the slag chemistry, the nano-sized solid crystals forming within the molten slag begin to interfere with each other and start to form clusters. This clustering leads to a viscosity increase within the slowly crystallizing slag.

During laboratory testing, for example, slags were heated to 1600° C. and then cooled at a rate of 5° C. per minute while the viscosity was measured. The results showed that the onset of crystallization does not immediately lead to an abrupt increase in viscosity. The velocity increase may only occur when the quantity of crystals exceeds a threshold and a larger crystalline microstructure begins to form. This testing showed that for a BOF slag, the first solid crystals begin to form at 1,506° C. as the 100% liquid slag is cooling. This point is defined as the crystallization temperature. After being cooled to around 1,300° C., most crystals or dendrites may still randomly be distributed and the distance between crystals or dendrites is a few times larger than the crystals themselves (approximately 20 μm).

While considering the rheology of a suspension of solids within a liquid when the solid particles are far apart, the solid particles can translate and rotate independently without interacting with each other. In this condition, it is the liquid fraction that dictates the slag viscosity. Below this temperature and liquid fraction, the solid fraction begins to dictate the slag viscosity. In the laboratory cooling of BOF slags, depending on the initial chemistry of the slag, the critical viscosity temperature is between 1250° C. and 1350° C., with the critical volume of solids determined to be between 30% and 50%. Around these temperatures and solid fractions, the viscosity of the slag remains below 10,000 mPa-s or 10 Pa-s [Pascal-seconds], which is similar to the viscosity of honey. The uppermost viscosity at which the energy extraction should cease is considered to be around 25 P-s. Studies have shown that the maximum viscosity which will allow a coal slag to freely flow out of a combustion reactor is around 25 Pa-s or 250 poise. where 1 Pa-s equals 10 poise. Additional investigations have also identified a maximum viscosity of 25 Pa-s to remove slag from an entrained gasifier.

When studying the viscosity of various slag compositions similar to BOF and EAF slags at different temperatures, the liquid fraction dominates the flow characteristic of the slag at higher temperatures, where the viscosity is generally 1 P-s or less which is similar to that of water. Once the temperature drops into a range where the solid fraction begins to dominate the flow properties, the viscosity begins to rapidly increase. This viscosity transition is also affected by the chemistry of the atmosphere above the molten slag. Under a reducing atmosphere, the temperature range at which the viscosity rapidly increases is generally 100° C. below where the same viscosity values are seen under an oxidizing atmosphere. Under an oxidizing atmosphere, the test slag viscosity rapidly increased to 5 P-s at 1,350° C., to 10 P-s at 1,325 degrees C., to 25 P-s at 1,300° C. and to 100 P-s at 1,250° C. For the same slag under a reducing atmosphere, the viscosity increased to 5 P-s at 1,250° C., to 10 P-s at 1,225° C., to 25 P-s at 1,200° C. and to 100 P-s at 1,175° C. Therefore, depending on the atmosphere in contact with the slag, in one aspect of the invention, the temperature at which the energy extraction should cease for BOF slags is between 1,200° C. and 1,300° C., for example, to keep the slag viscosity below 25 P-s.

However, molten BOF slags are also known to be pseudoplastic or “shear thinning” fluids. In these fluids, the viscosity decreases as a force is applied to the fluid. This is the case when moving an object, like a treatment vessel, through the bulk of the molten, solidifying slag. When the fluid, or molten, slag is in a resting state, the crystals forming into agglomerates are suspended in a random orientation. When a force is applied in one direction, the solid crystal network forming through crystal agglomeration is broken up as the crystals become oriented in the shear direction. Therefore, as the shear force breaks up the agglomerated crystal network forming within the slowly solidifying slag, the slag becomes free to again flow with a decreased viscosity. This effectively expands the temperature range in which energy extraction can be conducted for a slowly solidifying slag while using this process according to aspects of the invention. According to one aspect, by breaking up the larger crystal network forming within the slag, the treatment vessel can continue to remain within the volume of the slag at lower temperatures and for a longer period of time, and be moved around as necessary to accelerate energy extraction, as disclosed herein, before removal is required. As the energy extraction can now proceed down to where higher levels of solid fractions exist within the slag, in one aspect, some of the latent heat of fusion released during crystallization can then also be accessed which thereby increases the overall amount of energy extraction possible from any slag pot. This is an unexpected benefit of the process according to aspects of the invention, even for those skilled in the art of energy recovery from slags.

When considering the total amount of energy contained within a molten steel slag (approximately 1.6 GJ/T), only a portion of that energy is typically available to be extracted before the slag reaches a critical viscosity at a given solids fraction. In one aspect, this solids fraction is considered to be between 30% and 50%, or around 35% for typical BOF slags. At an initial slag energy extraction temperature in the slag pot of around 1,600° C. and a final energy extraction temperature of around 1,300 degrees C., which indicates around a 20% temperature drop, the energy released will be approximately 16% of the total sensible energy contained within the slag. Therefore, if 16% of the 1.6 GJ/T of slag is available for extraction, then around 256 MJ/T slag may be available for recovery and reuse in the higher temperature range. An additional 5-7% of the total energy may also be available for extraction while the temperature drops into the 35% crystalline range when solid and liquid fractions co-exist within the slag and the energy recovery can continue due to the shear-thinning effect on the slag viscosity. The latent heat of fusion is estimated to be approximately 15% of the total energy contained within the slag. However, assuming a threshold solids fraction of 35% in the slag upon cessation of the energy extraction process, only approximately 35% of the additional energy from the latent heat of fusion may be available for recovery which, including the above 256 MJ/T, equals a total of 340 MJ/T, or 21% of the energy available per tonne of slag. Therefore, in one aspect of the invention, a slag pot containing 30T of liquid BOF slag at 1,600° C. may have between 9.6-12 GJ of total energy available for extraction and utilization.

In one aspect, BOF slag, when contained within a 30T slag pot, may show very slow levels of cooling, which indicates that once in the slag pot, according to one aspect, only the slag at the surface and in contact with the pot sidewalls may show any appreciable level of cooling when the slag remains in the pot for many hours. The temperature of the slag in the center of a pot may show only a very slight decrease in temperature during the first two hours of cooling within the slag pot as the average temperature of the slag may only drop around 100° C., which may only be a 6% decrease in slag temperature when the pot was not covered by a lid. Also, in one aspect, the average temperature of the slag in the slag pot may only slightly higher when the pot was covered by a lid.

In one aspect, in high productivity EAF steel shops, the use of electrical energy is augmented by injecting carbon and oxygen into the slag in the furnace to generate chemical energy and cause slag foaming. This injection typically accelerates scrap melting and increases the overall steel production by decreasing the furnace tap-to-tap time. More heats of steel per day can then be produced from a single furnace. As some unreacted carbon can still be present within the slag after it is discharged into the slag pot, the unconsumed carbon may continue to react with the liquid FeO in the slag. This may cause more slag foaming in the slag pot and additional energy to be released into the slag. As foaming may cause the slag to circulate within the slag pot, foaming may thereby increase the amount of direct contact between the bulk of the slag volume and the treatment vessel surface, while helping to equilibrate the temperature within the overall slag volume. This may enhance the rate of energy transfer between the entire slag volume and the treatment vessel. If this gas-driven slag circulation is sufficient to maintain an acceptable rate of energy transfer between the slag and the treatment vessel, then, in one aspect, the need to circulate (that is, translate) or rotate the graphite treatment vessel within the pot could be minimized or eliminated. Additionally, as slag foaming out of a pot causes operational maintenance issues for the steel mill, the immersion, as well as any circulation (that is, translation) or rotation of the treatment vessel into and through the slag according to aspects of the invention may be helpful in that the treatment vessel may break up the bubble network in the slag foam to release the gases trapped within that cause the foaming. In one aspect, when the gases are quickly released from the slag, the foam partially collapses and drops the slag height to prevent slag from overflowing out of the slag pot. This may decrease the maintenance cleaning required in the area, in one aspect of the invention.

According to one aspect, the introduction of carbon/oxygen (for example, by injection) may also generate higher EAF slag temperatures and FeO levels compared to those temperatures usually seen in BOF slags. While BOF slags typically contain 20-25% FeO at temperatures around 1,600° C., EAF slags can contain over 30% FeO at temperatures of 1,650° C. or higher. Higher FeO levels may allow EAF slags to begin to crystallize at lower temperatures than BOF slags. The higher initial EAF slag temperature, combined with the lower threshold for the onset of crystallization, increases the amount of energy that can be removed from the EAF slag before the energy extraction process must be terminated. In the DTA (Differential Thermal Analysis) curves shown for various EAF slag chemistries, the slag crystallization begins at temperatures as low as 1,225° C. after which solidification continues at temperatures down to 1,050° C. Even assuming an initial slag temperature of 1,600° C. for starting energy extraction, and a final slag temperature of 1,200 degrees C. for treatment vessel removal, the amount of energy available for extraction, in one aspect, is thereby increased to 345 MJ/T for EAF slags, which is equal to 22% of the sensible energy within the slag. In one aspect, when 35% of the latent heat of fusion is added, the total energy for extraction may be 429 MJ/T, or around 27% of the total energy contained within the EAF steel slag. However, as EAF's usually have smaller metal capacities than BOF's (for example, 150T vs 230T), the weight of slag in the slag pot is usually closer to 20T than 30T. In this case, in one aspect, the total amount of energy available for recovery is estimated to be 8-10 GJ for a slag pot containing 20 T of EAF slag.

According to aspects of the invention, the applications for utilizing the energy emitted from within the central heated chamber of the hollow treatment vessel are numerous. These include, but are not limited to, the gasification of coal; the reformation of hydrocarbons; the decomposition of methane to generate carbon monoxide and hydrogen synthesis gas for use in chemical reduction reactions; the pyrolysis of printed circuit board scrap to again generate synthesis gas as well as separate the precious metals contained for subsequent recovery; the collection, removal, and storage of energy via use of molten-salt phase-change materials; the generation of steam; the direct generation of electricity by using modern semiconductors with a thermoelectric effect for converting radiant energy directly to electricity; and the melting and consolidation of finely-sized scrap metals, like aluminum, copper, brass and bronze to facilitate reuse. An ideal application for aspect of the invention is the processing of waste dusts, sludges, scales, and refractories, for example, that are generated on-site at the steel plant. These materials could thereby be valorized to generate useful products while minimizing their disposal, as well as the costs related to their disposal. In one aspect, in this way, the waste energy from molten slags is not only recovered on-site at a steel mill, but is also utilized on-site to process the solid waste materials generated at the same mill or other steel mills. One high-value application of aspects of the invention is the processing and deconstruction of EAF steelmaking dusts which contain significant amounts of high-value zinc from the EAF melting of galvanized steel scrap.

As the steel industry moves toward decarbonization, the number of EAF steelmaking facilities is increasing at the expense of traditional integrated steelmaking, which relies on BF's and BOF's. The BF/BOF steelmaking CO₂ footprint is 1.987 tonnes CO₂/tonne steel vs. 0.357 for EAF steelmaking. The ratio of EAF vs. BF/BOF steel plants in the USA is now (in 2024) 70/30 while in the 1960's this ratio was 30/70, which is also the current ratio for most steelmaking countries around the world. With the increasing conversion toward a greater percent of EAF steelmaking globally, the amount of EAF dust will continue to increase as ˜1.7% of EAF dust is generated per tonne of liquid steel melted. The current generation of EAF dust is estimated to be about 7 million tonnes per year [MTPY]-10 MTPY globally, from which only 45% of the EAF dust is recycled, mostly using the Waelz kiln process. Although there is great value in recovering the zinc contents, which can be up to 40%, but are typically 20-25% by weight, most of the EAF dust is landfilled due to the cost, scale, and complexity of the currently available zinc [Zn] recovery processes. The EAF dust that is not recycled must be disposed of in hazardous landfills due to the zinc, lead, and other heavy metals typically contained in the EAF dust.

As known in the art, the main process for Zn recovery from EAF dust is the Waelz rotary kiln, which requires a large quantity (greater than 50 kilotonnes per year [KTPY]) of typically greater than 15% Zn dust to be economically viable. As most EAF steel plants produce 1 MTPY or less of liquid steel, they do not generate enough EAF dust to economically justify their own Waelz kiln. The EAF dust from multiple mills must therefore typically be shipped to common sites that are sized to process the EAF dusts from many different EAF steel plants. For the estimated 60 MTPY of EAF steel production in the USA, only seven Waelz kilns with a total capacity of 570 KTPY are available to process the estimated 1 MTPY of EAF dust generated. In addition to the problem of scale, the Waelz kiln process is very energy intensive, which is undesirable from environmental and cost viewpoints. Additionally, the Waelz slag remaining after fuming off the zinc still contains some zinc (3-5%) and therefore the Waelz slag is classified as a hazardous material for transport and landfilling. Lower process temperatures are required in the Waelz kiln, typically 1,100° C.-1,200° C., to prevent low melting point accretions from adhering to the interior walls of the kiln. As the process conditions do not result in most of the iron oxide being converted to metallic iron after processing, the metallic Fe content of the Waelz slag (less than 10%) is too low for remelting in the EAF. Other uses must therefore be found for the Waelz slag to prevent landfilling this by-product, which is approximately half of the weight of the dust entering the process. Also, as the pelletized EAF dust remains in the kiln for 4-6 hours, much carbon combustion-generated energy is required to keep the pellets hot for this extended period of time. As well, large volumes of 700° C.-800° C. off-gas are emitted which not only releases excess CO₂ into the atmosphere, but also draws much energy out of the kiln causing more energy inefficiency within the process. While processing the EAF dust in the kiln, the EAF dust and carbon charge mixture creates a reducing gas environment in the solids bed which reduces the zinc oxide and zinc ferrite in the EAF dust to metallic zinc vapor that is released into the gas phase of the kiln. However, as the gas phase in the kiln is primarily oxidizing, the metallic zinc vapor is reoxidized to zinc oxide dust which then exits the kiln in the off-gas. This high-grade zinc oxide product must typically then be subsequently reduced again to zinc metal in a separate pyro—or hydrometallurgical process which incurs more transport, capital, and operational expenses. Finally, as the Waelz kiln rotates, the pellet bed undergoes degradation thereby generating more EAF dust that is typically lost in the off-gas and creates another process inefficiency.

Despite these drawbacks, the Waelz kiln process is still designated by the EPA as the BDAT or “Best Demonstrated Available Technology” for EAF dust treatment to recover most of the zinc in the EAF dust and prevent landfilling much of the EAF dust generated globally. Therefore, a technology which utilizes on-site dust processing while allowing for complete utilization of the metallic and oxide products generated, such as, aspects of the present invention, would be a preferable solution to the ever-increasing amounts of EAF dust produced each year.

An alternative to the Waelz kiln is the RHF or “Rotary Hearth Furnace” which operates at temperatures between 1,250° C. and 1,350° C. and is used by companies including Midrex, ZincOx, Paul Wurth and Nippon Steel. In the Midrex “Fastmet” RHF process, the EAF dust is mixed with carbon and pelletized to between 10-20 millimeters [mm] before being dried and then fed into the RHF where the pellets are exposed to the high temperatures from a combustion flame for 6-12 minutes. During this time, the zinc oxides and ferrites in the EAF dust are chemically reduced to Zn and Fe metal. Zinc metal vapor is fumed off and subsequently oxidized before being collected as zinc oxide dust for conversion into metallic zinc in a separate pyro—or hydrometallurgical process. Additionally, a high-grade metallic iron product is also formed which can be remelted in the EAF steelmaking process. The recovery of zinc in the RHF is over 95% and the direct metallization of iron is over 90%. However, the costs of building and operating an RHF are much higher than those associated with the Waelz kiln. Like the Fastmet process, which uses an RHF, aspects of the present invention also operate at high enough temperatures to get high recoveries of the Zn and Fe in less than 15 minutes. This is just one of the many advantages of aspects of the present invention over the Waelz kiln process.

Aspects of the present invention use energy extracted from molten slag rather than from a separate furnace or kiln, and the large capital expense required for an RHF (greater than $200 M) or a Waelz kiln (greater than $100 M) is avoided. Since one aspect of the invention may be operated on-site at a steel mill, the need to transport the EAF dust long distances to a common processing facility (typically sized for 50,000 T to 250,000 T of dust/yr.) may be avoided. In small scale, on-site processing, aspects of the invention may allow for more of the EAF dust generated globally to be viably processed compared to less than 50% as—processed now. Accordingly, aspects of the invention may increase the amount of Zn and Fe recovered and reduce the amount of EAF dust that is landfilled compared to prior art methods.

Another benefit of aspects of the invention is that the zinc vapor fumed off the EAF dust pellets can be directly condensed into a metallic zinc product, instead of being necessarily converted to zinc oxide during the process. In one aspect, since no air-entrainment is required to support the combustion of carbon for energy generation, the atmosphere within the hot chamber of the treatment vessel immersed in the molten slag can be reducing or inert. Thus, in one aspect, a zinc oxide or a metallic zinc product can therefore be produced, depending on the preference of the operator. The subsequent need to convert ZnO to Zn, which is required in the Waelz kiln and RHF processes, can therefore be avoided, thereby incurring huge savings in overall capital expense, operating expense, and transport costs. According to aspects of the invention, the total CO₂ emissions generated within the RHF and Waelz kiln processes, as well as when transporting the ZnO product for further processing to generate Zn metal, may also be greatly reduced, for example, by 50% or more, to decrease the total quantity of greenhouse gas generated per ton of zinc recovered, compared to the prior art.

Finally, aspects of the invention may generate much lower volumes of off-gas from a stationary rather than a tumbling bed of pellets, for example, the dust losses according to an aspect of the invention are much lower than the dust losses in the Waelz rotary kiln EAF dust treatment process. The lower off-gas volumes of aspects of the invention may also minimize the energy losses from the reaction zone to increase the overall energy efficiency of the process.

According to aspects of the invention, a process or method is provided which involves the immersion of a graphite treatment vessel, which has been hollowed out from one end, into a molten medium containment vessel, such as a slag pot filled with molten slag in the range of 1,500° C. to 1,750° C. that has been generated from a metal melting or refining furnace. In one aspect, pelletized EAF dust is added to the internal chamber within the treatment vessel, either alone or as a mixture with a carbonaceous reductant, so that the radiant energy within the internal chamber heats the EAF dust pellets to the temperatures required to chemically reduce and vaporize the Zn within the EAF dust pellets, and the vaporized Zn is then released in the off-gas through the top of the treatment vessel. The relatively small amount of off-gas, which contains the Zn vapor, is then channeled through a collection pipe placed over the top of the treatment vessel after adding the pellet charge. In one aspect, the metallic Zn vapor can then either be oxidized to collect a high-grade ZnO dust, like in the RHF process, or the metallic Zn vapor can be directed into a zinc condenser for recovery of a metallic zinc product. After the zinc has fumed off, the remaining metallic Fe/slag co-product is removed from the treatment vessel for use, for example, as an alternate source of metallic iron and calcined lime flux in the charge of a melting furnace. As the chemical reduction and fuming off of the zinc occurs in 6-12 minutes when exposed to the 1,250 degrees C. to 1,600° C. temperatures within the treatment vessel, in one aspect, it may be possible to process 2-3 separate batches of EAF pellets in the treatment vessel using the same slag pot before the temperature and viscosity change in the molten slag require that the process be terminated in that, for example, first, slag pot, but then continued in a new, for example, second, slag pot, which may be generated every 20-90 minutes within the typical production cycle of a modern steel plant. In one aspect, an ongoing, semi-continuous cycle of EAF dust processing may thereby be provided on-site, for example, at a steel plant for treating steel mill waste dusts.

In one aspect, in order to facilitate energy transmission from the radiating inner surface of the internal chamber of the treatment vessel to the center of the EAF pellet charge within that chamber, many techniques are available. These include mixing the EAF pellets with high thermal conductivity materials, such as metals or highly carbonaceous substances, before charging into the treatment vessel. In one aspect, a gas injection pipe made from a high melting point material, such as, stainless steel or superalloy, may be inserted down to the bottom of the internal chamber before the EAF pellet charge is added. According to this aspect, a very low gas flow can be injected into the chamber to create a temperature-equalizing effect within the EAF pellet bed, which also may provide “flushing” of any Zn vapor from inside the internal chamber for capture outside of the treatment vessel, for example, either as a metallic vapor or as a high purity zinc oxide dust, if air is allowed to enter the off-gas collection pipe as the zinc is flushed from the chamber. In one aspect, a high melting point, thermally conductive insert can also be placed inside the chamber of the treatment vessel, for example, before adding the EAF dust pellets to the chamber. In one aspect, the thermally conductive insert may promote the even distribution of temperature throughout the entire EAF pellet charge. In another aspect, more than one internal chamber may be provided within the treatment vessel. In one aspect, more than one separate “treatment chambers” may be created, which may then individually hold the EAF pellets to be reduced. In one aspect, the insertion of the thermally conductive insert, for example, an elongated, cylindrical insert, may reduce the distance between the high thermal conductivity graphite treatment vessel to the center of each EAF pellet charge and thereby may reduce or improve the energy transfer rate to the center of each EAF pellet charge. In one aspect, the insertion of the thermally conductive insert to the internal treatment chamber may reduce the time required to complete the chemical reduction of the zinc oxides and ferrites in the EAF dust pellets, and the fuming off of the Zn.

In one aspect, in order to facilitate the ease and speed of adding and removing the EAF pellet charge from the treatment vessel, including while the treatment vessel remains immersed in the molten slag, the EAF pellets may be pre-loaded into a separate container, such as, a high melting point, high thermal conductivity substance container, or a first substance container, which may then be lowered into the, for example, heated, internal chamber of the treatment vessel. In one aspect, after the zinc has been fumed off from the EAF pellets in the first substance container, the substance container can then be removed from the treatment vessel, and a second, typically pre-loaded, substance container can be lowered, for example, quickly lowered, into the chamber of the treatment vessel. In one aspect, while this new, second substance container is being heated, the extracted first substance container may be emptied of the remaining hot, Fe-lime co-product and reloaded with the next charge of EAF pellets for subsequent addition to the treatment vessel. In one aspect, a rotating cycle of EAF dust pellet additions may thereby be provided to maximize the use of the energy contained within the molten slag of the slag pot, while substantially simultaneously processing as much of the EAF dust as possible with the molten slag energy available.

In one aspect, after fuming off the zinc, the remaining metallized Fe-containing co-product may still be at the elevated reaction temperature achieved in the chamber of the treatment vessel. In one aspect, as the energy extraction and dust reduction process occurs on a steel mill site, the hot, metallized Fe-containing co-product may be discharged into an insulated container or hopper, and, for example, the metallized EAF pellets from the hopper may be introduced to the furnace, for example, while the metallized Fe-containing co-product is still at an elevated temperature. Accordingly, in one aspect, an increased energy efficiency may be provided in the next EAF/BOF scrap melting cycle.

In one aspect, during each energy extraction cycle in each slag pot, the graphite treatment vessel may be moved around as necessary to continue accessing the high temperature zones within the volume of the molten slag. This is because the slag temperature decreases next to the treatment vessel as energy is extracted from the slag, and also because the low thermal conductivity of the slag hinders temperature equalization within the volume of the slag in the slag pot. Movement of the graphite treatment vessel within the volume of the slag according to aspect of the intention may also act to break up any network of crystals that forms as the slag cools, thereby extending the time that the treatment vessel can be immersed and increasing the total energy that can be extracted from the slag before the treatment vessel must be removed from the slag pot. In one aspect, the treatment vessel, for example, a first treatment vessel, may remain immersed in the molten slag of the slag pot, for example, a first slag pot, for between 20-60 minutes before the slag in the slag pot becomes too viscous to continue immersion. In one aspect, the next, or a second, slag pot containing molten slag generated from the metal melting process may be delivered, and then the first or a second treatment vessel having a substance in its chamber may be immersed in the second slag pot to continue treatment in the first treatment vessel or initiate the energy extraction and utilization process in the new, or second, slag pot. Accordingly, in one aspect a “semi-continuous” energy extraction and utilization process may be provided. It is envisioned that, according to aspects of the invention, a permanent slag energy extraction and EAF dust pellet processing station may be set up at or near a steel mill for extracting and utilizing energy from the molten slag that is generated substantially continuously, for example, throughout all hours and days of each year. For example, in one aspect, as the amount of molten slag generated is ˜13% of the molten steel weight, and the EAF dust generated is ˜1.7% of the molten steel weight, it is envisioned that substantially all of the EAF dust generated in a steel shop may be processed into Zn-rich and Fe-rich products with virtually no waste by using the waste slag energy available on-site at the steel plant by employing aspects of the invention. In one aspect, if a surplus of EAF dust remains, it is envisioned that the surplus EAF dust pellets could be transported to the nearest BOF steel plant for processing in the larger BOF slag pots. In one aspect, BOF dust could also be used to recover the Zn and Fe from this BOF waste and make use of the energy in the BOF slag.

Alternately, according to one aspect of the invention, the BOF slag energy can be extracted by the same methodology and put to use on-site for some of the alternate high temperature processing opportunities outlined earlier, including processing BF and BOF dusts, scales, and sludges. As there are currently large stockpiles of BF and BOF dust building up on-site at integrated steel plants due to the zinc content making them unrecyclable in the plant in their current form, as well as carbon-rich fines, in one aspect, this low capital and operating cost solution to remove the Zn could be very useful to eliminate the legacy cost of these waste stockpiles and recover the valuable zinc and iron metals contained while using on-site carbon fines.

In one aspect, since the process temperatures created in the treatment vessel chamber are sufficient to generate a highly metallized Fe/flux product that is acceptable for remelting in the EAF as an alternate scrap source, complete recovery of the Zn is not necessary from each batch of pellets. Any minor amount of Zn remaining in the metallized Fe product may then be volatilized during the next EAF melting cycle to again transfer the Zn into the EAF gas/dust for recovery when that dust is sent to the Zn recovery process.

In one aspect, since the gas exiting the treatment vessel can be used to determine when the Zn removal from the pellets has been completed, the off-gas volume, chemistry, and/or temperature may be monitored throughout the process. In one aspect, monitoring the off-gas may also be possible to divert any sodium (Na) and/or any potassium (K) vapors that are released from the EAF dust before the Zn vapors are released. Accordingly, in one aspect of the invention, a higher-quality zinc oxide or metallic zinc product with low Na and K contents may thereby be generated at a higher value to the zinc-product customer.

In one aspect, to further increase the efficiency of aspects of the invention, the small amount of off-gas generated, which will be mostly CO once the Zn has been removed, can be directed for use of the sensible heat contained to dry other materials, fore example, to dry on-site material, such as, sludges, or to dry the green (moist) EAF dust pellets produced by aspects of the invention. Also, in one aspect, the calorific value of the off-gas can be used to generate heat for use in other processes, or used “as is” as a reducing gas to be re-introduced into the reaction chamber within the treatment vessel, for example, to help reduce the Zn and Fe oxides in the EAF dust. In one aspect, the off-gas can also be directed over the slag in the slag pot to maintain a reducing gas environment over the slowly solidifying slag surface in the slag pot to, for example, extend the time in which the energy can be extracted by lowering the crystallization temperature of the slag in the slag pot. In one aspect, the CO gas generated can also be used to chemically reduce iron oxide pellets in a Direct Reduced Iron (DRI) process, for example, separate from the process of extracting and utilizing energy from the molten slag in a slag pot. In one aspect, since integrated steel plant processes are now being converted from BF/BOF-based operations to DRI/EAF-based operations, the reducing gas remaining from the Zn reduction process may be used upstream in an on-site DRI production process to augment the CO/H₂ reducing gas used in the DRI process and may thereby increase the total process efficiency.

A further benefit of aspects of the invention is that aspects of the invention may be conducted within a transportable slag pot, that is, a slag pot that can be moved and located as desired. For example, aspects of the invention may not need to interfere with the steelmaking operation, since aspects of the intention may be conducted away from, that is, remote from, the core steelmaking activities of furnace charging, melting, and casting. Therefore, in one aspect, no interference with daily steelmaking activities may be created, thereby allowing the energy extraction and utilization to proceed as a separate process conducted in a remote area away from the steel making but within the steel mill grounds.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic illustration of a system and method for treating a substance according to one aspect of the invention.

FIG. 2 is a schematic illustration of the temperature-resistant vessel at least partially immersed in the high-temperature medium in the slag pot as shown in FIG. 1 according to one aspect of the invention.

FIG. 3 is a front perspective view of a temperature-resistant vessel that may be used in the system and method shown in FIGS. 1 and 2.

FIG. 4 is a cross-sectional view of the temperature-resistant vessel shown in FIG. 3.

FIG. 5 is a front perspective view of another temperature-resistant vessel that may be used in the systems shown in FIGS. 1 and 2.

FIG. 6 is a front perspective view of a further temperature-resistant vessel that may be used in the systems shown in FIGS. 1 and 2.

FIG. 7 is a schematic illustration of another system and method for treating a substance according to another aspect of the invention.

### DETAILED DESCRIPTION OF ASPECTS OF THE INVENTION

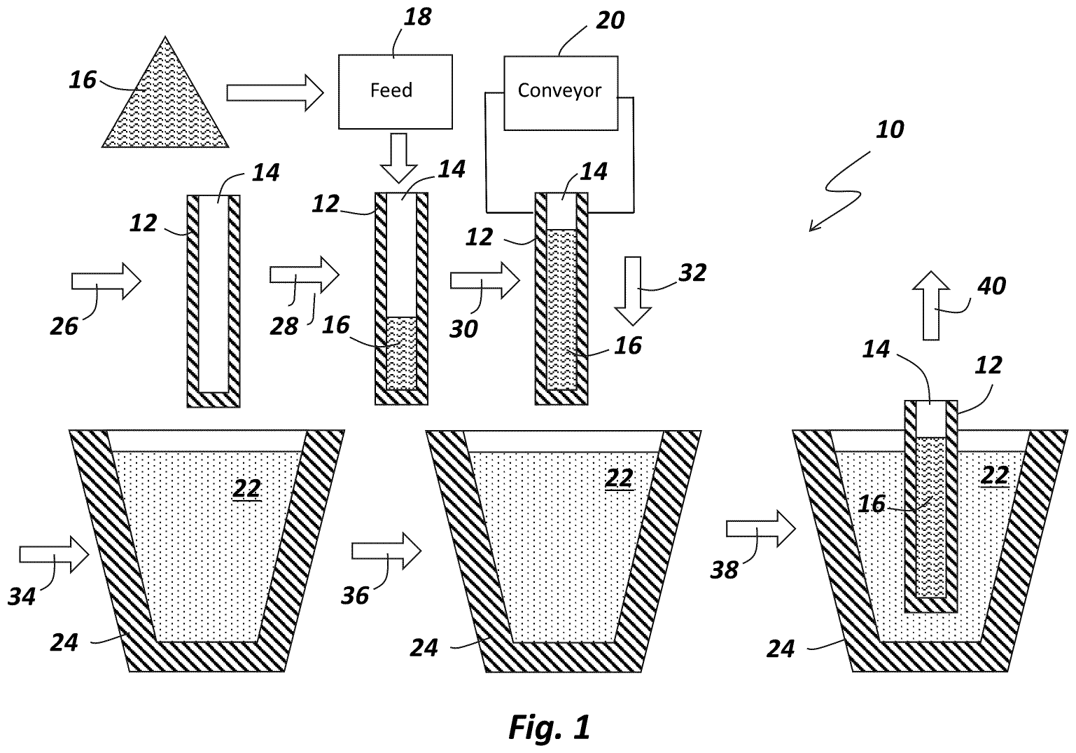

FIG. 1 is a schematic illustration of a system and method 10 for treating a substance according to one aspect of the invention. As shown in FIG. 1, system and method 10 includes a temperature-resistant vessel, treatment vessel, 12 having one or more internal cavities 14 adapted to receive a substance 16, for example, a substance to be thermally treated; a feed system 18 having an outlet positioned to introduce the substance 16 into the one or more internal cavities 14 of the temperature-resistant vessel 12; and a conveyor system 20 adapted to at least partially immerse the temperature-resistant vessel 12 containing the substance 16 into a high-temperature medium 22 having a temperature greater than 1,000° C., for example, a high-temperature medium temperature, and adapted to remove the temperature-resistant vessel 12 from the high-temperature medium 22. In FIG. 1, temperature resistant vessel 12 is shown schematically in cross-section to facilitate disclosure of aspects of the invention.

Though in some aspects of the invention, the container may be referred to as “a temperature resistant vessel,” according to some aspects of the invention, though referred to as “a temperature resistant vessel,” the container or vessel referred to may comprise any suitable container and may be referred to as “a reactor,” “a vessel,” or “a treatment vessel,” for example, any container adapted to contain the desired process or reaction.

According to aspects of the invention, the temperature-resistant vessel 12 is adapted to treat the substance 16 in the one or more internal cavities 16 at a treatment temperature of the substance, for example, greater than 600° C., when the temperature-resistant vessel 12 is at least partially immersed into the high-temperature medium 22. For example, in order to withstand a temperature of at least 600 or 1,000 degrees C., temperature resistant vessel 12 is made from a temperature-resistant material, for example, a material that will not deform or fail at temperatures of at least 600 or 1,000° C., for example, a graphite-containing material, a magnesium oxide-containing material, a silicon carbide-containing material, and a refractory metal-containing material or one of their equivalents. In one aspect, at least partially immersing the temperature-resistant vessel comprises exposing at least a portion of the temperature-resistant vessel above a level of the molten medium, for example, as shown in FIG. 1.

According to one aspect of the invention, a “temperature-resistant” vessel 12 is a vessel comprised of a shape and material that is not damaged, deformed, or structurally compromised when exposed to a temperature of at least 600° C., or at least 800° C., or at least 1,200° C.; or at least 1,400° C.; or at least 1,600° C. In one aspect, the temperature-resistant vessel 12 may be made from a material having a relatively high thermal conductivity, for example, wherein, when the external surface of the vessel 12 is exposed to the high-temperature medium 22, for example, molten slag, the thermal energy in the high-temperature medium 22 may readily transfer through the walls of the vessel 12 and into the one or more internal cavities 14 and to the substance 16 in the cavity being treated. In one aspect, the thermal conductivity of the material of vessel 12 may be greater than the thermal conductivity of the high-temperature medium 22, for example, having a thermal conductivity at least 5 times greater or at least 50 times greater than the thermal conductivity of the high-temperature medium 22. Though it is known in the art that the thermal conductivity of a material may vary with temperature, crystal structure, and direction through the material (for example, axial or radial), among other things, in one aspect, the temperature-resistant vessel 12 may be made from a material having a thermal conductivity of at least 10 watts per meter-Kelvin (W/mK), or at least 100 W/mK, or at least 150 W/mK at room temperature, that is, about 20° C. In one aspect, the temperature-resistant vessel may be made of a graphite having a thermal conductivity of between 120 W/mK and 180 W/mK, for example, about 150 W/mK at room temperature.

Though the source of the high-temperature medium 22 may be provided by any conventional source of high-temperature medium, for example, a high-temperature fluid medium, in one aspect, the high-temperature medium 22 may be a molten medium produced or related to the production or treatment of ferrous or non-ferrous materials, for example, from a steel production process in a steel mill. In one aspect, the high-temperature medium 22 may be any molten ferrous or non-ferrous medium. In one aspect, the high-temperature medium 22 may be a molten slag, for example, molten slag from steel production. For example, as shown in FIG. 1, high-temperature medium 22 may be provided in a molten medium containment vessel such as a “slag pot” 24, as known in the art. Though in the following discussion the molten medium containment vessel 24 may be referred to as a “slag pot” to facilitate disclosure of aspects of the invention, aspects of the invention are not limited to the use of slag pots, for example, vessel 24 may be any type of containment vessel or conduit adapted to contain, or channel the flow of, the high-temperature medium 22. Aspects of the invention may be practiced using any available source of high-temperature media 22, and may be provided with or without a containment vessel 24. For example, in one aspect of the invention, vessel 24 may be a slag pot, a steel ladle, a furnace, a slag runner, or a furnace tapping spout.

The schematic illustration of system 10 shown in FIG. 1 represents a progressive handling of temperature-resistant vessel 12 and slag pot 24. Specifically, in FIG. 1, temperature-resistant vessel 12 is shown progressively as being introduced to system 10, for example, from storage or from a prior treatment according to aspects of the invention, as indicated by arrow 26; temperature-resistant vessel 12 is moved to a location for introduction of substance 16 from feed system 18, as indicated by arrow 28; after introduction of substance 16, temperature-resistant vessel 12 is positioned for immersion into slag pot 24, as indicated by arrow 30; and then the temperature-resistant vessel 12 is at least partially immersed into the high-temperature medium 22 in slag pot 24, as indicated by arrow 32. In one aspect, this movement and handling of temperature-resistant vessel 12 may be provided by conveyor 28 and/or related structures. According to aspects of the invention, the substance 16 may comprise one or more of steel making furnace dust, for example, EAF dust; steel mill sludge; steel mill finishing shot blast residue; steel mill scale; other by-product or scrap metals; by-product carbon units remaining from the iron and/or steel production process; used steel making refractory-based materials; carbon-containing solids and gases; molten-salt phase-change materials or thermoelectric materials, among other substances.

Similarly, FIG. 1 schematically illustrates the progressive movement of slag pot 24 from introduction to system 10, for example, from the vicinity of a furnace, such as, an EAF or a BOF, as indicated by arrow 34, and slag pot 24 is progressively positioned before introduction of temperature-resistant vessel 12 as indicated by arrow 36. After introduction of temperature-resistant vessel 12 into the high-temperature medium 22 in slag pot 24, substance 16 is allowed to be treated at a treatment temperature as indicated by arrow 38. In one aspect, the high-temperature medium 22 may have a temperature, or a high-temperature medium temperature, that may be greater than the treatment temperature experienced by the substance 16 in treatment vessel 12.

In one aspect, prior to introducing the temperature-resistant vessel 12 to the slag pot 24, temperature-resistant vessel 12 may be introduced to thermal treatment in a high-temperature medium in a different vessel, for example, to a liquid steel in a furnace or a liquid steel in a ladle. For example, in one aspect, the treatment of the substance 16 may be initiated or “kick-started” by introducing the temperature resistant treatment vessel 12 containing substance 16 to a first vessel or pretreatment vessel (not shown), different from slag pot 24. In one aspect, the thermal treatment in the first vessel may be practiced to at least partially increase the temperature of the high temperature-resistant treatment vessel 12 and, perhaps, increase the temperature of the substance 16, for example, relatively rapidly increase the temperature, prior to introducing the high temperature-resistant treatment vessel 12 to slag pot 24, where thermal treatment may be continued.

The substance 16 that is treated by system 10 may be any substance that could benefit by treatment at elevated temperature. For example, according to aspects of the invention, substance 16 may be one or more substances that chemically react at elevated temperature, one or more substances that convert energy at elevated temperature, or one or more substances that transfer energy at elevated temperature, such as, at least 600° C., or at least 700° C., or at least 800° C., or at least 900 degrees C., or at least 1,000° C. For instance, substance 16 may be coal that is being gasified at elevated temperature, a hydrocarbon that is being reformed at elevated temperature, methane being decomposed at elevated temperature to generate carbon monoxide and hydrogen synthesis gas, separation of precious metals from a waste electronic substrate at elevated temperature, a molten-salt phase-change material with which energy is extracted from vessel 12 at elevated temperature, a water-containing substance from which steam is being generated at elevated temperature, a substance having thermo-electric properties from which electrical energy is being generated at elevated temperature, waste steel making refractory materials and the by-products of treating aluminum salt slag that are calcined, or metal scrap being melted at elevated temperature, among other substances. In one aspect, substance 16 may be a product, a by-product, and/or a co-product of a ferrous or non-ferrous metal production and finishing process. For example, in one aspect, substance 16 may be an Electric Arc Furnace (EAF) waste dust, for instance, EAF waste dust containing zinc compounds, wherein treating at elevated temperature generates zinc-containing off-gases which are preferably captured to recover and utilize the zinc and to minimize release into the environment.

Feed system 18 of system 10 may be any appropriate material handling system adapted to transfer substance 16 from a source location, for example, a storage location, to the temperature-resistant vessel 12. Conveyor system 20 may be any conveyor system adapted to engage and move temperature-resistant vessel 12, for example, having a manipulator or crane adapted to lower temperature-resistant vessel 12 into high-temperature medium 22 and subsequently remove the temperature-resistant vessel 12 from high-temperature medium 22, as indicated by arrow 40.

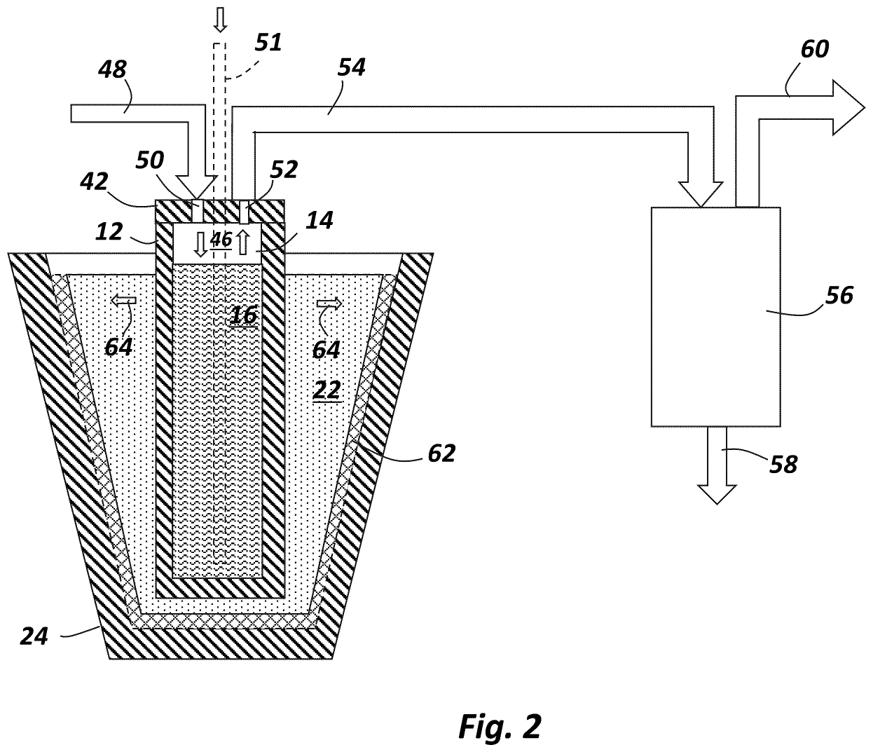

FIG. 2 is a schematic illustration of the temperature-resistant vessel 12 at least partially immersed in the high-temperature medium 22 in slag pot 24 shown in FIG. 1 according to one aspect of the invention. As shown in FIG. 2, while at least partially immersed in high-temperature medium 22, temperature-resistant vessel 12 heated by direct contact with high-temperature medium 22, for example, at a medium temperature of at least 1,000° C. In addition, due to the heating of temperature-resistant vessel 12 by high-temperature medium 22, substance 16 positioned in temperature-resistant vessel 12 may be indirectly heated via, for example, thermal radiation emitting from the inside walls of temperature-resistant vessel 12. According to one aspect, the temperature of substance 16 may be heated to a target or treatment temperature, for example, of at least 600° C. in a heating time or heating ramp-up time of 5 to 60 minutes [mins.], for example, between 7 mins. and 40 mins. In another aspect, substance 16 may be held at the target or treatment temperatures for 10 mins. to 30 mins., for example, 12 mins. to 20 mins., before the temperature-resistant vessel 12 is removed from the high-temperature medium 22. In one aspect, the target temperature, treatment temperature, or temperature of the substance during treatment may be at least 600° C., at least 700° C., at least 800° C., at least 1,000° C., at least 1,200° C., at least 1,400 degrees C., or at least 1,600° C.

It is understood that, due to, among other things, the magnitudes and differences in temperatures that may be present between the molten slag 22, the vessel 12, and the substance 16 being treated in vessel 12, temperature gradients are likely to be present in the substance 16 during treatment. For example, it is believed that, during treatment, the temperature of substance 16 in contact with or proximate to the internal surfaces of internal cavity 14 of vessel 12 may be higher in temperature than substance 16 distal or away from the internal surface of internal cavity 14—for example, proximate the centerline of internal cavity 14. In one aspect, these temperature gradients through the horizontal cross section of the internal cavity 14 may be referred to as “radial temperature gradients.” In addition, it is believed that temperature gradients may also be present in the substance 16 from the bottom of the internal cavity 14 to the top surface of substance 16 proximate the top of internal cavity 14. In one aspect, these temperature gradients through the vertical cross section of the internal cavity 14 may be referred to as “longitudinal temperature gradients.” According to an aspect of the invention, the target or treatment temperature to which substance 16 may be elevated to may be a function of the radial temperature gradient and/or the longitudinal temperature gradient within substance 16. For example, in one aspect, the target or treatment temperature may be the mean or the average temperature of the substance 16, for example, the mean or the average temperature of the bulk substance 16 over these gradients.

In one aspect, as shown in FIG. 2, the temperature-resistant vessel 12 may be provided with an isolating cover 42, for example, a gas-collecting cover. Cover 42 may be provided to collect any gases emitted from the substance 16 positioned in temperature-resistant vessel 12, for example, to enhance the collection of zinc fumes coming off a substance 16 positioned in temperature-resistant vessel 12. In one aspect, cover 42 may be made of a temperature-resistant material, for example, a steel, a stainless steel, a nickel alloy, a graphite, or a super alloy, among others.

As also shown in FIG. 2, in one aspect, a treatment or purge fluid, for example, a reducing or inert gas, may be introduced to treatment vessel 12 via one or more conduits or pipes 51, for example, after the introduction of substance 16 into vessel 12. In one aspect, the one or more treatment solids or gases may be introduced to substance 16, for example, one or more conduits or pipes 51 directed into substance 16. In one aspect, the one or more solid or gas additions to substance 16 may enhance the thermal conductivity of the substance 16, and/or enhance the energy dispersion rate of the substance 16, among other enhancements. As shown in FIG. 2, the one or more conduits or pipes 51 may have a distal outlet proximate or adjacent to the bottom of internal cavity 14 of treatment vessel 12. In one aspect, cover 42 may be provided to isolate or complete the enclosure of the void space 46 above the surface of substance 16 in cavity 14. For example, in one aspect, the content of void space 46 may be monitored and/or controlled to prevent the uncontrolled release into the surrounding atmosphere of the gases and/or solid participate generated during the treatment, for example, the reactions occurring within the substance 16.

In one aspect, cover 42 may be provided to isolate or complete the enclosure of the void space 46 above the surface of substance 16 in cavity 14 in order to capture any gases in void space 46, for example, to capture any off-gases generated or evolved from the treatment of substance 16. For example, in one aspect, any gas present or generated in void space 46 may be monitored and/or controlled to thereby monitor the treatment, for example, the reaction taking place in cavity 14. In one aspect, any gas present or generated in void space may be captured and discharged from void space 46 via one or more holes or ports 52 in cover 42 and one or more conduits 54. In one aspect, when the thermal treatment of substance 16 in temperature-resistant vessel 12 generates toxic or otherwise noxious gases, the gases can be captured, removed, or redirected via one or more conduits 54 and forwarded for reuse, treatment, or disposal.

As also shown in FIG. 2, in one aspect, one or more gas treatment processes or devices 56 may be provided to process, treat, and/or capture any gases generated in high-temperature vessel 12. For example, the one or more conduits 54 from high-temperature vessel 12 may be operatively connected to one or more gas treatment processes or devices 56. In one aspect, treatment process or device 56 may be a metal separator adapted to collect any metal vapors and/or solid participate present in the gases, such as, off-gases, generated in high-temperature vessel 12. For example, in one aspect, treatment device 56 may be adapted to collect at least some of the metal vapors generated in high-temperature vessel 12 to produce a metal-rich stream in conduit 58 and a metal-depleted stream in conduit 60. For example, in one aspect, when the substance 16 treated in high-temperature vessel 12 comprises EAF waste dust containing zinc compounds, the thermal treatment in high-temperature vessel 12 may generate zinc-containing vapors or gases, for example, by volatilizing at least some of the zinc from the EAF waste dust, and treatment device 56 may be a zinc-isolating or a zinc-condensing device producing a zinc-rich stream in conduit 58 and a zinc-depleted stream in conduit 60. In one aspect, the EAF waste dust may be provided in any conventional form, including, but not limited to, in a powdered form, in a granulated form, in a pelletized form, in a tableted form, in a briquetted form, or in an extruded form. In another aspect, the metallic zinc vapors coming off the substance during high temperature treatment may be oxidized in the off-gas stream conduit 54 and subsequently removed as a solid particulate by gas filters in the gas treatment device 56.

In one aspect, slag pot 24 may include at least some insulation 62 to minimize the escape of thermal energy from slag pot 24. In one aspect, the minimization of the loss of thermal energy from slag pot 24 may facilitate the heating, maintenance, and/or stabilization of the target treatment temperature in high-temperature vessel 12. In one aspect, the loss of thermal energy from slag pot 24 may be minimized by introducing a thermal barrier to the open top of slag pot 24 or to the surface of high-temperatures medium 22 in slag pot 24. For example, in one aspect, an insulating barrier, such as, burnt rice hulls, perlite, vermiculite, or diatomaceous earth, may be distributed upon the exposed upper surface of the high-temperature medium 22 to reduce heat loss from high-temperature medium 22.

In one aspect, temperature-resistant vessel 12 is moved or translated and/or rotated within and/or relative to the high-temperature medium 22 as indicated by arrows 64 in FIG. 2. For example, in one aspect, translating and/or rotating of the at least partially immersed, temperature-resistant vessel 12 within the high-temperature medium 22 may be practiced by moving the temperature-resistant vessel 12 in a path, for example, a predefined path, at a speed, for example, a predefined speed, to enhance temperature transfer from the high-temperature medium 22 to the temperature resistant vessel 12 and ultimately to the substance 16. In one aspect, the high-temperature medium 22 may be moved relative to the temperature-resistant vessel 12 to enhance temperature transfer from the high-temperature medium 22 to the temperature resistant vessel 12 and ultimately to the substance 16. The translation, rotation, or movement of temperature-resistant vessel 12 within the high-temperature medium 22 may be practiced using conveyor system 20, shown in FIG. 1. In one aspect, translating and/or rotating the at least partially immersed, temperature-resistant vessel 12 within the high-temperature medium 22 may be practiced to break up at least some of any solidified high-temperature medium 22, for example, slag plate, that may form, and thus may enhance the extraction of energy from the high-temperature medium 22. In one aspect, in addition to or in place of moving, rotating, or translating the temperature-resistant vessel 12, the high-temperature medium 22 may be placed in motion relative to the temperature-resistant vessel 12 to enhance temperature transfer from the high-temperature medium 22 to the temperature-resistant vessel 12. In one aspect, to enhance temperature transfer from the high-temperature medium 22 to the temperature resistant vessel 12, the slag pot 24 containing the high-temperature medium 22, for example, molten slag, may be moved relative to the temperature-resistant vessel 12, to expose the temperature-resistant vessel 12 to hotter regions of the high-temperature medium 22. For example, the slag pot 24 may be rotated and/or translated while the temperature-resistant vessel 12 is held or remains relatively stationary. In one aspect, both the slag pot 24 and the temperature resistant vessel 12 may both be translated and/or rotated to enhance temperature transfer from the high-temperature medium 22 to the temperature resistant vessel 12.

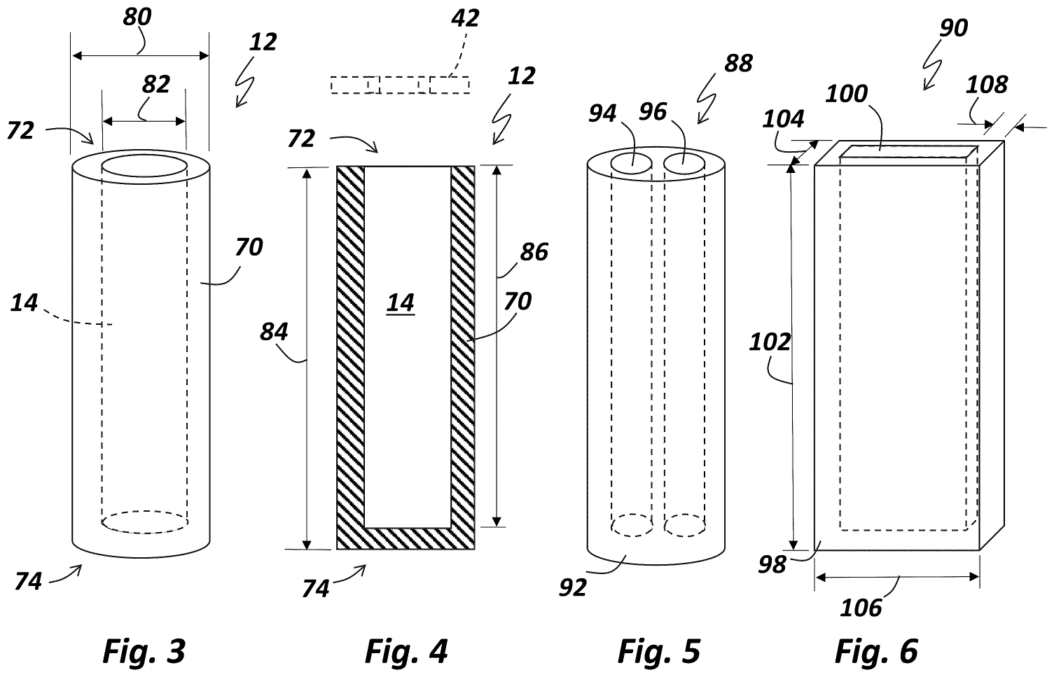

FIG. 3 is a front perspective view of a temperature-resistant vessel 12 that may be used in the system 10 and method shown in FIGS. 1 and 2. FIG. 4 is a cross-sectional view of the temperature-resistant vessel 12 shown in FIG. 3. As shown in FIGS. 3 and 4, in this aspect, high-temperature vessel 12 includes a temperature-resistant cylindrical body 70 having at least one internal cavity 14, for example, only one internal cavity, adapted to receive substance 16 (not shown) for treatment. The cylindrical body 70 is adapted to withstand a temperature of at least 600° C. or at least 1,000° C. without failure or deformation. In one aspect, cylindrical body 70 may comprise a “temperature-resistant” cylindrical body as disclosed herein, for example, having a shape and material that is not damaged, deformed, or structurally compromised when exposed to a temperature of at least 600 degrees C., or at least 800° C., or at least 1,200° C.; or at least 1,400 degrees C.; or at least 1,600° C. In one aspect, the temperature-resistant cylindrical body 70 may be made from a material having a relatively high thermal conductivity as disclosed herein, for example, cylindrical body 70 may be made of a graphite having a thermal conductivity of between 120 W/mK and 180 W/mK, for example, about 150 W/mK at room temperature. According to aspects of the invention, the temperature-resistant cylindrical body 70 may comprise a graphite-containing cylindrical body, for example, cylindrical body 70 may comprise substantially only graphite. Accordingly, in one aspect, temperature-resistant vessel 12 may be referred to as “a graphite treatment vessel.” In other aspects, temperature-resistant cylindrical body 70 may be made from a magnesium oxide-containing material, a silicon carbide-containing material, or a refractory metal-containing material, among other temperature-resistant materials.

In one aspect, though shown substantially as circular cylindrical in FIGS. 3 and 4, cylindrical body 70 may be an elliptical cylindrical body or a polygonal cylindrical body, for example, square cylindrical, pentagonal cylindrical, or hexagonal cylindrical, among other polygonal cylindrical shapes. As known in the art, the term “cylindrical” is not limited to a cylindrical shape having a circular cross section, but may have other non-circular cross sections. Specifically, according to one aspect of the invention, a cylindrical body comprises an elongated, substantially solid or partially solid body having a cross section substantially perpendicular to the direction of elongation of the solid that is characterized by a planar shape, for example, a circle, an ellipse, a square, or any other polygon. In one aspect, the cylindrical body 70 may be a prismatic body. For example, in one aspect, cylindrical body 70 may have a polygonal cylindrical shape comprising a “slab” of heat-resistant material having one or more internal cavities 14.

The at least one internal cavity 14, for example, only one internal cavity, may be an open internal cavity and have an open end 72 and a closed end 74, opposite open end 72. As shown in phantom in FIG. 4, temperature-resistant vessel 12 may have a removable cover 42 adapted to mount over or to the open end 72, and the removable cover 42 may include one or more holes or gas ports. Removable cover 42 may be made from a temperature-resistant material, such as, a steel, a stainless steel, a nickel alloy, a super alloy, a graphite-based material, or refractory-based material.

As shown in FIG. 3, the outer dimension or outer diameter 80 of cylindrical body 70 of vessel 12 may range from 6 inches [in.] to 4 feet [ft.], but may typically range from 12 in. to 3 ft., for example, about 32 in. The inner dimension or inner diameter 82 of internal cavity 14 may range from 6 in. to 36 in., for example, about 24 in. As shown in FIG. 4, the height 84 of cylindrical body 70 may range from 2 ft. to 12 ft., but may typically range from 4 ft. to 10 ft., for example, about 7 ft. The height or depth 86 of inner cavity 14 may range from 1 ft. to 10 ft., but may typically range from 2.5 ft. to 9 ft., for example, about 6 ft.

FIG. 5 is a front perspective view of a temperature-resistant vessel 88, similar to temperature-resistant vessel 12, having a plurality of internal cavities 94 and 96 according to one aspect of the invention. Temperature-resistant vessel 88 shown in FIG. 5 may have all the properties of temperature-resistant treatment vessel 12 and have a cylindrical body 92. However, in contrast to temperature-resistant vessel 12, temperature-resistant vessel 88 includes at least two (2) internal cavities 94 and 96 adapted to receive a substance for treatment at elevated temperature. As shown in FIG. 5, internal cavities 94 and 96 may be elongated, circular cylindrical cavities having open ends for receiving a substance and closed bottoms.

FIG. 6 is a front perspective view of a temperature-resistant vessel 90, similar to temperature-resistant treatment vessel 12, having a rectangular cylindrical or rectangular prismatic shape, which may be referred to as comprising a “slab” of temperature-resistant material, for example, a graphite, according to one aspect of the invention. Temperature-resistant vessel 90 shown in FIG. 6 may have all the properties of temperature-resistant vessel 12, and have a rectangular cylindrical or rectangular prismatic body 98 having at least one internal cavity 100 adapted to receive a substance for treatment at elevated temperature. As shown in FIG. 6, the one or more internal cavities 100 may be elongated, rectangular cylindrical or elongated, rectangular prismatic cavities having an open end for receiving a substance and a closed bottom. In one aspect, the one or more internal cavities 100 may be elongated, circular cylindrical or elongated, ellipsoidal cylindrical, or elongated rectangular cavities.

As shown in FIG. 6, the body 98 of temperature-resistant vessel 90 may have a height 102, a width 104, a length 106, and a wall thickness 108. According to aspects of the invention, height 102 may range from 2 ft. to 12 ft., but typically, ranges from 4 ft. feet to 10 ft., for example, about 6 ft.; width 104 may range from 6 inches to 6 ft., but typically, ranges from 1 ft. to 4 ft., for example, about 2 ft.; length 106 may range from 2 ft. to 12 ft., but typically, ranges from 3 ft. to 7 ft., for example, about 5 ft.; and wall thickness 108 may range from ¼ inch to 2 ft., but typically, ranges from 1 inch to 6 inches, for example, about 4 inches.

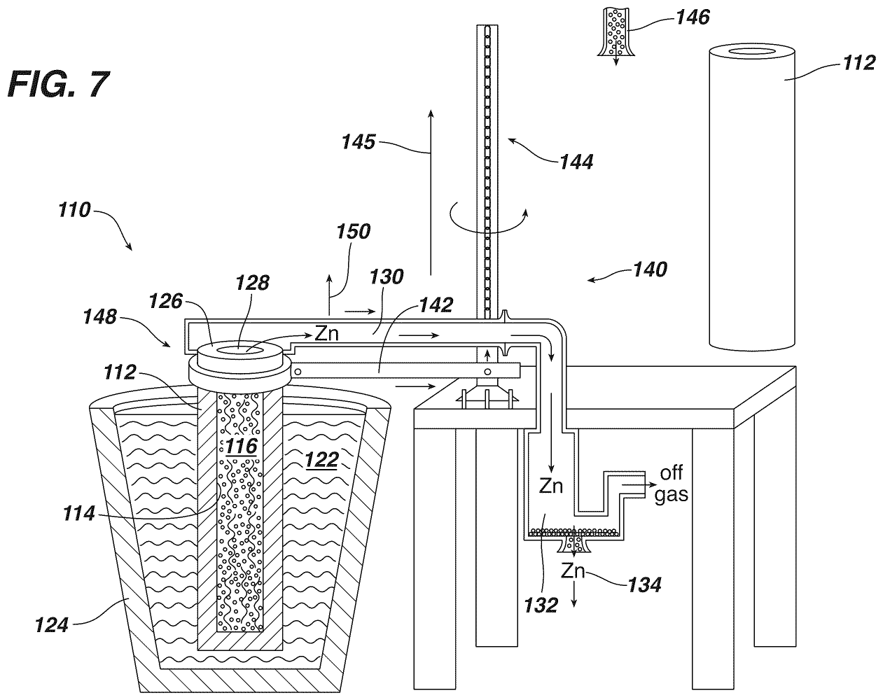

FIG. 7 is a schematic illustration of another system 110 and method for treating a substance according to another aspect of the invention. As shown in FIG. 7, system 110 includes a temperature-resistant vessel 112, similar to and having all the properties of temperature-resistant vessel 12 disclosed herein, having one or more internal cavities 114 adapted to receive a substance 116, for example, a substance to be thermally treated. Temperature-resistant vessel 112 having the substance 116 is at least partially immersed in a high-temperature medium 122 located in a slag pot 124, in a manner similar to the invention disclose herein.

In the aspect shown in FIG. 7, temperature-resistant vessel 112 includes a cover 126 having a hole or port 128 which is in fluid communication with one or more conduits 130 that passes any gases from temperature-resistant vessel 112 to a gas treatment device 132, for example, a solid particulate filter or a metal separator. For example, treatment device 132 may be a zinc separator, as disclosed herein, for isolating or collecting zinc 134 from the gas discharged from temperature-resistant vessel 12.

As shown in FIG. 7, in one aspect, system 110 may include a conveyor system 140 adapted to at least partially immerse the temperature-resistant vessel 112 containing the substance 116 into a high-temperature medium 122. As shown, conveyor system 140 may include a conveyor arm 142 adapted to engage, for example, mechanically grasp, the temperature-resistant vessel 112. Conveyor arm 142 may be operatively mounted to a conveyor device 144, for example, a chain-based or a screw-based conveyor device, allowing conveyor system 140 to move temperature-resistant vessel 112 as disclosed herein. For example, conveyor system 140 may be adapted to introduce vessel 112 and withdraw vessel 112 from high-temperature medium 122 (as indicated by arrow 145), and/or position vessel 112 where vessel 112 can receive substance 116, for example, from a pellet feeder 146. As also shown in FIG. 7, in one aspect, cover 126 of vessel 112 may comprise a cover assembly 148 including the one or more conduits 130 which may be adapted to be mounted and unmounted (as indicated by arrow 150) upon temperature-resistant vessel 112.

As disclosed herein, methods, systems, and treatment vessels are provided for extracting energy from a molten medium, for example, a molten metal slag produced in metal processing located in a slag pot. The methods and systems employ heat-resistant treatment vessels having an internal cavity adapted to contain a substance to be thermally treated. The treatment vessels containing the substance being treated are immersed into the molten medium and the heat of the molten medium is used to promote the desired treatment of the substance. Aspects of the present invention distinguish from the existing art while recovering and utilizing energy that is typically wasted. Aspects of the invention can provide a cost-effective means of not only thermally treating substances, but also capturing otherwise wasted sources of energy and reducing or minimizing the environmental impact of metals processing.

The terminology used herein is for the purpose of describing particular embodiments only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method of treating a substance comprising:
introducing a substance into an internal cavity of a temperature-resistant vessel;
at least partially immersing the temperature-resistant vessel containing the substance into a high-temperature molten medium having a temperature greater than 1,000° C.;
allowing the temperature-resistant vessel to be heated by the high temperature molten medium wherein the substance is heated to a treatment temperature; and
treating the substance in the internal cavity of the temperature-resistant vessel at the treatment temperature.

2. The method as recited in claim 1, wherein the substance comprises one or more of steel making furnace dust, steel mill sludge, steel mill finishing shot blast residue, steel mill scale, steel mill by-product, steel mill scrap metal, by-product carbon units from the iron or steel production process, used steel making refractory-based materials, carbon-containing solids and gases, molten salt phase change materials and thermoelectric materials.

3. The method as recited in claim 1, wherein the high-temperature molten medium comprises one more of a molten metal slag and a molten metal.

4. The method as recited in claim 1, wherein the high-temperature molten medium is positioned in one of a slag pot, a steel ladle, a furnace, a slag runner, and a furnace tapping spout.

5. The method as recited in claim 1, wherein at least partially immersing the temperature-resistant vessel comprises exposing at least a portion of the temperature-resistant vessel above a level of the molten medium.

6. The method as recited in claim 1, wherein the temperature-resistant vessel comprises one of a graphite-containing vessel and a refractory material-containing vessel.

7-8. (canceled)

9. The method as recited in claim 1, wherein the method further comprises translating or rotating the at least partially immersed, temperature-resistant vessel within the high-temperature molten medium.

10-20. (canceled)

21. The method as recited in claim 1, wherein the method further comprises, after treating, removing the temperature-resistant vessel from the high-temperature molten medium, and wherein the high-temperature medium comprises a first high-temperature medium, and wherein, after removing the temperature-resistant vessel from the first high-temperature medium, at least partially immersing the temperature-resistant vessel into a second high-temperature medium, different from the first high-temperature medium.

22-30. (canceled)

31. The method as recited in claim 1, wherein treating the substance in the internal cavity generates off-gases, and wherein the method further comprises collecting the off-gases from the treating.

32-48. (canceled)

49. The method as recited in claim 1, wherein treating comprises one or more of chemically reacting, energy converting, and energy transferring.

50. The method as recited in claim 1, wherein the substance comprises EAF waste dust containing zinc compounds, and wherein treating comprises extracting at least some of the zinc from the zinc compounds from the EAF waste dust.

51-54. (canceled)

55. The method as recited in claim 1, wherein the method further comprises introducing at least one of a thermal conductivity enhancing material and an energy dispersion rate enhancing material into the substance in the temperature-resistant vessel.

56. (canceled)

57. The method as recited in claim 1, wherein the treatment temperature comprises at least 700° C.

58-60. (canceled)

61. A system for treating a substance comprising:
a temperature-resistant vessel having an internal cavity adapted to receive a substance;
a feed system having an outlet positioned to introduce the substance into the internal cavity of the temperature-resistant vessel; and
a conveyor system adapted to at least partially immerse the temperature-resistant vessel containing the substance into a high-temperature molten medium having a temperature greater than 1000° C. and adapted to remove the temperature-resistant vessel from the high-temperature molten medium;
wherein the temperature-resistant vessel is adapted to treat the substance in the internal cavity at a treatment temperature when the temperature-resistant vessel is at least partially immersed into the high-temperature molten medium.

62. (canceled)

63. The system as recited in claim 61, wherein the substance comprises at least one of steel making furnace dust, steel mill sludge, steel mill finishing shot blast residue, steel mill scale, steel mill by-product, steel mill scrap metal, by-product carbon units from the iron or steel production process, used steel making refractory-based materials, carbon-containing solids and gases, molten salt phase change materials and thermoelectric materials.

64-78. (canceled)

79. The system as recited in claim 61, wherein the treatment temperature comprises a temperature of at least 700° C.

80. The system as recited in claim 79, wherein the conveyor system is adapted to remove the temperature-resistant vessel from the high-temperature molten medium after a treatment time of 5 mins. to 60 mins.

81. A high-temperature treatment vessel comprising:
a temperature-resistant cylindrical body having at least one internal cavity adapted to receive a substance for treatment;
wherein the cylindrical body is adapted to withstand a temperature of at least 1,000° C. without failure or deformation.

82-84. (canceled)

85. The treatment vessel as recited in claim 81, wherein the cylindrical body comprises one of a circular cylindrical body, an elliptical cylindrical body, and a polygonal cylindrical body.

86. The treatment vessel as recited in claim 81, wherein the at least one internal cavity comprises at least one open internal cavity having an open end, and wherein the treatment vessel further comprises a removable cover adapted to mount to the open end.

87-115. (canceled)
